(19) United States
(12) Patent Application Publication
(10) Pub. No.: US 2018/0080854 A1
(43) Pub. Date: Mar. 22, 2018

(54) VEHICLE IMPACT TESTING

(71) Applicant: Ford Global Technologies, LLC, Dearborn, MI (US)

(72) Inventors: Mahmoud Yousef Ghannam, Canton, MI (US); Clara Bennie, Sterling Heights, MI (US); Roy Joseph Scott, Saline, MI (US); John Wilson, Newport, MI (US)

(73) Assignee: Ford Global Technologies, LLC, Dearborn, MI (US)

(21) Appl. No.: 15/270,347

(22) Filed: Sep. 20, 2016

(51) Int. Cl. G01M 17/007; G01N 3/307

(52) U.S. Cl. CPC G01M 17/0078; G01N 3/307

(57) ABSTRACT

A system, includes a base and a track supported by the base. The system includes a block movably attached to the track. The block is arranged to increase a pressure in a pressure chamber. A pressure sensor is attachable to the pressure chamber. The pressure sensor is programmed to collect pressure data from the pressure chamber when the block increases the pressure in the pressure chamber.

### BACKGROUND

Vehicles undergo tests including simulated and/or actual impacts with other objects. The impact tests typically use sensors such as pressure sensors installed in the vehicle. The pressure sensors collect pressure data from an enclosed chamber. The pressure data can be used to detect a vehicle impact. For example, the pressure sensor may be installed in a vehicle door to detect a side impact. Testing the pressure sensors in a vehicle may be cumbersome, time-consuming, and costly.

### BRIEF DESCRIPTION OF THE DRAWINGS

FIG. 1 is a view of an example impact test system.

FIG. 2A is a top view of the impact test system of FIG. 1.

FIG. 2B is a cross-sectional view of the impact test system of FIG. 1.

FIG. 3 is a view of the impact test system of FIG. 1 upon releasing a spring.

FIG. 4 is a view of an example pressure chamber used in the impact test system of FIG. 1.

FIG. 5 is a view of another example impact test system.

FIG. 6A is a top view of the impact test system of FIG. 5.

FIG. 6B is a cross-sectional view of the impact test system of FIG. 5.

FIG. 7 is a view of the impact test system of FIG. 5 upon releasing a spring.

### DETAILED DESCRIPTION

An impact test system simulates a side impact of a vehicle. The impact test system includes a base and a track supported by the base. The base includes an impact surface The impact test system includes a block movably attached to the track. The impact test system includes a pressure chamber attachable to one of the block and the impact surface, and a pressure sensor attachable to the pressure chamber. The block is connected to the base with a spring. Upon releasing the spring, the block moves toward the impact surface, increasing the pressure in the pressure chamber. By using the spring to compress the pressure chamber between the block and the impact surface, the impact test system can produce different forces to simulate different side impacts. Thus, the impact test system can simulate different crash events and test different pressure sensors without using a vehicle door, reducing the cost of testing the pressure sensors.

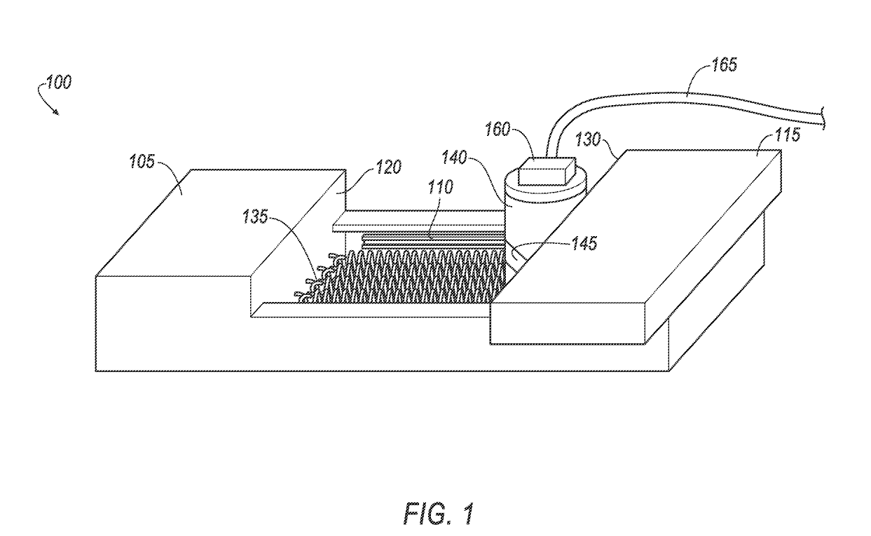

FIGS. 1-4 illustrate an example impact test system 100. The impact test system 100 includes a base 105. The base 105 supports a track 110. The track 110 is fixedly attached to the base 105. The track 110 may extend along a length of the base 105. The track 110 allows a block 115 to move along the track 110 with respect to the base 105. The base 105 includes an impact surface 120. The impact surface 120 faces the block 115.

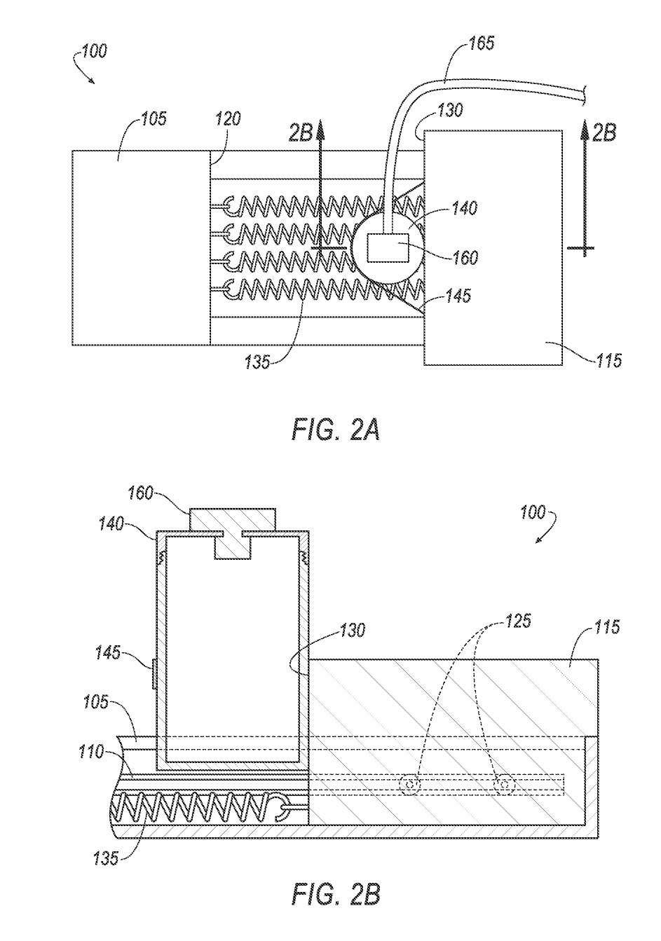

The system 100 includes the block 115. The block 115 may be supported by the base 105. The block 115 moves along the track 110 toward the impact surface 120. That is, the block 115 includes at least one sliding element 125 attached to the block 115 that engages the track 110. The sliding elements 125 allow the block 115 to move along the track 110. The sliding elements 125 may be, e.g., wheels as shown in FIG. 2B, bearings, etc. The block 115 includes a surface 130 facing the impact surface 120.

At least one spring 135 connects the base 105 to the block 115, as shown in FIGS. 1-2B. FIGS. 1-3 show four springs 135, and the impact test system 100 may include a different number of springs 135. The springs 135 may be tensioned as the block 115 moves away from the impact surface 120. When the block 115 is released, the tension in the springs 135 releases, moving the block 115 along the track 110 and toward the impact surface 120. That is, the springs 135 move the block 115 toward the impact surface 120 until the tension in the springs 135 releases and/or the block 115 contacts the impact surface 120. Alternatively, the block 115 may be moved toward the impact surface 120 with, e.g., a hydraulic actuator, a pneumatic actuator, etc.

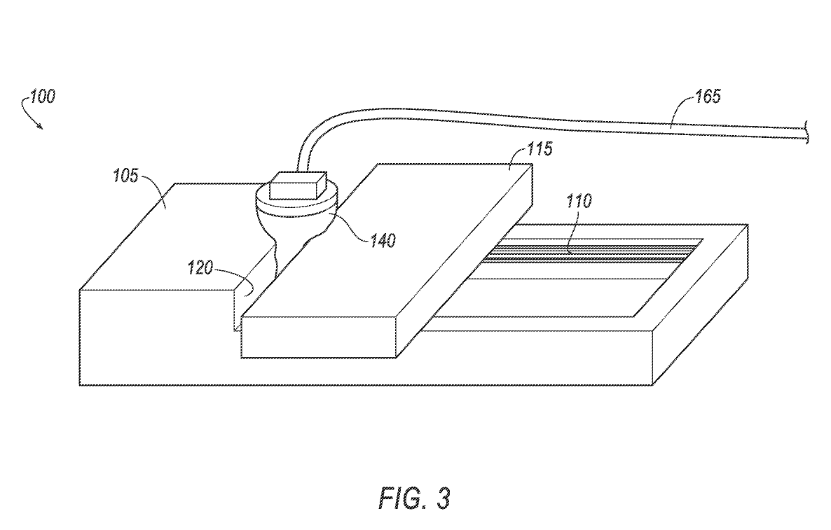

The system 100 includes a pressure chamber 140. In the example of FIGS. 1-4, the pressure chamber 140 is deformable from an undeformed state, as shown in FIG. 1, to a deformed state, as shown in FIG. 3. That is, the pressure chamber 140 may be attached to the block 115, as shown in FIG. 1, and when the springs 135 move the block 115 toward the impact surface 120, the block 115 compresses the pressure chamber 140 against the impact surface 120, as shown in FIG. 3. As a result, the volume of the pressure chamber 140 decreases and the pressure inside the pressure chamber 140 increases as the pressure chamber 140 deforms. The pressure chamber 140 may be attached to the block 115 with an attachment device 145, e.g., adhesive tape, a cable, a rivet, a screw, etc. FIGS. 1-2B show the attachment device 145 as a strip of adhesive tape. The springs 135 may be, tensioned so that the surface 130 of the block 115 and the impact surface 120 apply a specified amount of force on the pressure chamber 140, the force specified to simulate a side impact on a vehicle door. Furthermore, the springs 135 may be tensioned to apply different specified forces to the pressure chamber 140. Thus, the springs 135 can simulate a plurality of differing impact forces to simulate side impacts of different severity in different respective tests.

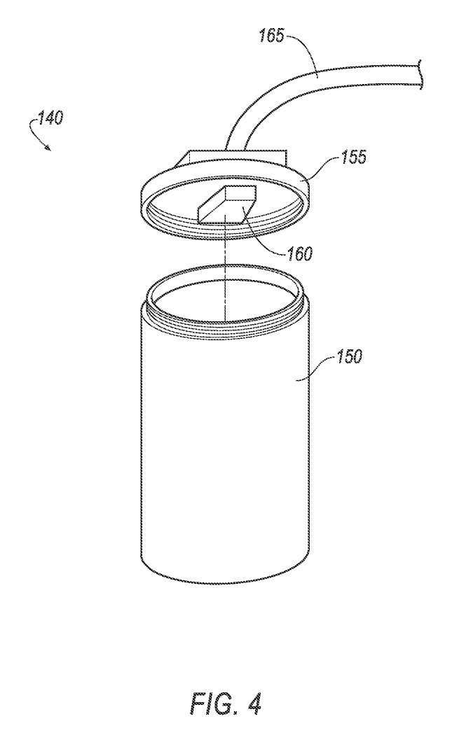

As shown in FIG. 4, the pressure chamber 140 may include a container 150 and a lid 155. The container 150 contains a volume of air. As the block 115 moves toward the impact surface 120, the block 115 compresses the container 150, decreasing the volume of the container 150, thereby increasing the pressure inside the container 150. The lid 155 seals the volume of air in the container 150. The lid 155 may be attachable to the container 150 via, e.g., threads as shown in FIG. 4, a friction fit, etc. The container 150 is constructed of a flexible and/or resilient material, e.g., a polymer, a composite, etc., that is deformable when compressed between the surface 130 of the block 115 and the impact surface 120.

The system 100 includes a pressure sensor 160, as shown in FIGS. 1-4. The pressure sensor 160 includes a processor and a memory such as is known, the memory storing instructions executable by the processor, such that the sensor 160 is programmed for various operations as disclosed herein, including to collect pressure data from the pressure chamber 140, specifically, the pressure in the container 150. As shown in FIG. 4, the pressure sensor 160 may be installed in the lid 155. At least a portion of the pressure sensor 160 may be attached to an inner surface of the lid 155, extending into the container 150. The pressure sensor 160 may be attached to the lid 155 with, e.g., an adhesive.

The pressure sensor 160 may be connected to a data transmitter 165, e.g., a wire, a cable, etc. Thus, the pressure sensor 160 can collect pressure data from the container 150 as the pressure chamber 140 is compressed and send the data along the transmitter 165. Alternatively, the data transmitter 165 may be a wireless transmitter installed in the pressure sensor 160 and may send the pressure data over a wireless network, e.g., WiFi, Bluetooth®, etc. A computing device (not shown) can use the pressure data when the pressure chamber 140 deforms from the undeformed state to the deformed state to detect when the pressure exceeds a pressure threshold. The pressure threshold indicates the pressure that at which one or more vehicle subsystems are programmed to actuate, indicating a side impact. Based on the tension in the springs 135, the pressure sensor 160 can collect pressure data for differing forces applied to the pressure chamber 140 and can determine whether the pressure data exceeds the pressure threshold. Thus, the pressure sensor 160 can be tested under differing impact conditions. Furthermore, because the cost of the pressure chamber 140 is less than a vehicle door, the cost to test the pressure sensor 160 is reduced.

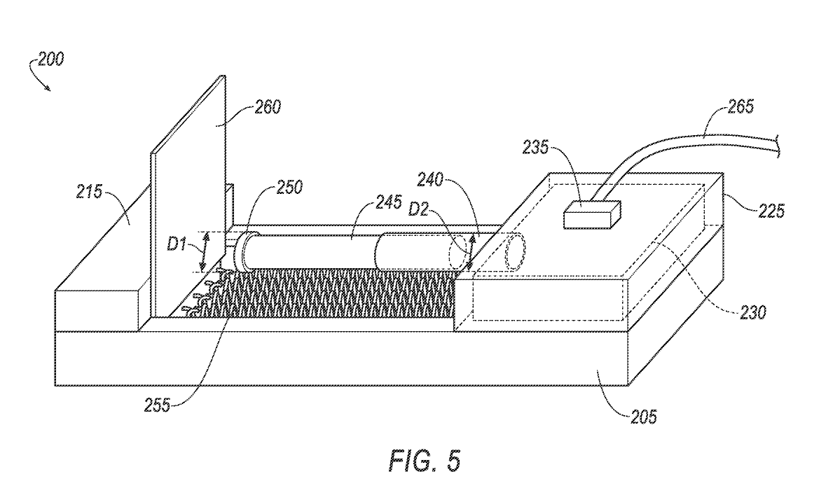

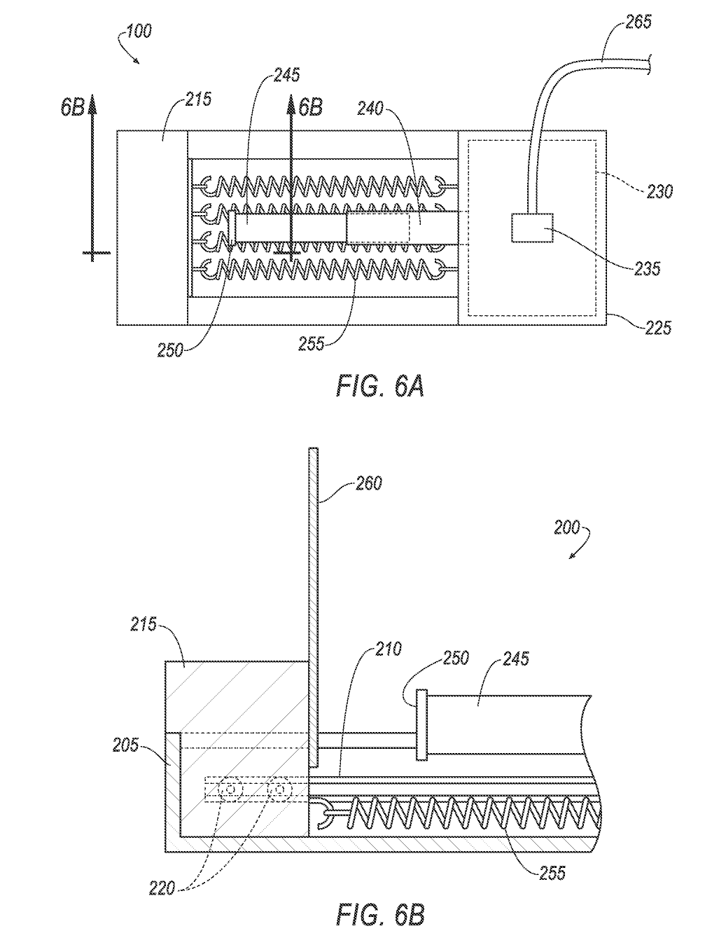

FIGS. 5-7 illustrate an example impact test system 200. The system 200 includes a base 205 and a track 210 supported by the base 205. As described above, the track 210 allows a block 215 to move along the base 205. As shown in FIG. 6B, the block 215 includes at least one sliding element 220 to move along the track 210. The sliding element 220 may be, e.g., a wheel, a bearing, etc.

The impact test system 200 includes a pressure chamber 225 affixed to the base 205. While the pressure chamber 140 of FIGS. 1-4 is deformable, the pressure chamber 225 of FIGS. 5-7 is substantially rigid. As used herein, the term “rigid” is intended to have its plain and ordinary meaning, and in the present context means that the pressure chamber 225 resists deformation and that an internal volume of the pressure chamber 225 does not change upon application of a force. That is, the volume of the deformable pressure chamber 140 changes upon application of a force as it deforms from the undeformed state to the deformed state. Upon applying a force to the non-deformable pressure chamber 225, being rigid, the pressure chamber 225 resists deformation, and the internal volume does not change. Furthermore, while the pressure chamber 140 of FIGS. 1-4 may be attached to the block 115, the pressure chamber 225 remains stationary and fixed to the base 205.

The pressure chamber 225 defines a cavity 230. Because the pressure chamber 225 is substantially rigid, the cavity 230 defines a fixed spatial volume. The cavity 230 may be filled with air. The impact test system 200 includes a pressure sensor 235 attached to the pressure chamber 225. The pressure sensor 235 includes a processor and a memory such as is known, the memory storing instructions executable by the processor, such that the sensor 235 is programmed for various operations as disclosed herein, including to collect pressure data, of the air pressure in the cavity 230. While illustrated as a cuboid, the cavity 230 may be a different shape, e.g., octagonal, hexagonal, elliptical, etc.

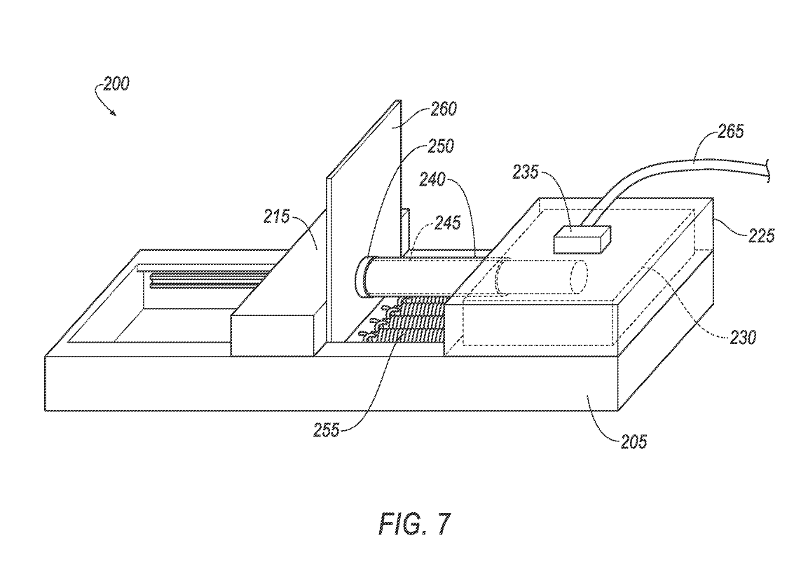

The impact test system 200 includes a tube 240 connected to the pressure chamber 225. The tube 240 houses a plunger 245. The plunger 245 is a solid cylinder arranged to move through the tube 240 into the cavity 230. The tube 240 is connected to the cavity 230 of the pressure chamber 225 to allow the plunger 245 to move through the tube 240 and into the cavity 230. That is, the plunger 245 starts in a first position, as shown in FIGS. 5-6B, where the plunger 245 extends out from the tube 240. The plunger 245 moves to a second position, as shown in FIG. 7, where at least a portion of the plunger 245 is pushed into the cavity 230. The plunger 245 is arranged to push air from the tube 240 into the cavity 230 of the pressure chamber 225. When the plunger 245 enters the cavity 230 in the second position, the air from the tube 240 and the displacement of the plunger 245 into the cavity 230 increases the air pressure in the pressure chamber 225.

The plunger 245 may include a flange 250 disposed outside the tube 240, as shown in FIG. 5-7. The flange 250 has a diameter D1 greater than a diameter D2 of the tube 240, preventing the plunger 245 from moving into tube 240 farther than the flange 250. The block 215 can contact the flange 250 to move the plunger 245 from the first position to the second position.

The impact test system 200 includes at least one spring 255. The example impact test system 200 includes four springs 255, as shown in FIGS. 5, 6A, and 7. The springs 255 connect the block 215 to the base 205, as shown in FIG. 6A. The springs 255 are tensioned as the block 215 moves away from the plunger 245. Upon releasing the springs 255, the tension releases, pulling the block 215 toward the plunger 245. The block 215 contacts the plunger 245, moving the plunger 245 toward the pressure chamber 225 and increasing the air pressure in the cavity 230, as shown in FIG. 7.

The block 215 may include a plate 260. As the block 215 moves toward the pressure chamber 225, the plate 260 contacts the flange 250, moving the plunger 245 into the cavity 230. The plate 260 may be attached to the block 215 with, e.g., an adhesive including a glue, adhesive tape, a hook-and-loop fastener, etc., and/or a fastener including nuts, bolts, screws, etc. The plate 260 reduces the size of the block 215 and allows the springs 255 to move the block 215 to apply a specified force on the flange 250. That is, the block 215 may be positioned below the flange 250, and thus the block 215 may not contact the flange 250 when moving along the track 210. The plate 260, when attached to the block 215, may extend above a top surface of the block 215 and may strike the flange 250 when the block 215 moves toward the plunger 245.

The pressure sensor 235 may be connected to a data transmitter 265, e.g., a wire, a cable, etc. The pressure sensor 235 sends pressure data along the data transmitter 265 to, e.g., a computing device (not shown). Alternatively, the data transmitter 265 may be a wireless transmitter installed in the pressure sensor 235 and may send the pressure data over a wireless network, e.g., WiFi, Bluetooth®, etc.

When the springs 255 move the block 215 toward the plunger 245, the plate 260 contacts the flange 250. The flange 250 moves the plunger 245 through the tube 240, pushing the air in front of the plunger 245 into the cavity 230, increasing the air pressure in the cavity 230. At least a portion of the plunger 245 may enter the cavity 230, displacing some of the air in the cavity 230 and further increasing the air pressure in the cavity 230. As the plunger 245 enters the cavity 230, the pressure sensor 235 collects pressure data from the cavity 230. Thus, a computing device (not shown) can use the pressure data to determine whether the force applied by the plate 260 onto the flange 250 increased the pressure in the cavity 230 above a predetermined pressure threshold, indicating a side impact. Based on the size of the block 215, the size of the plate 260, and the tension in the springs 255, the plate 260 may apply differing forces to the flange 250, simulating different forces that would be applied to a vehicle door during a side impact. Thus, the pressure sensor 235 can be tested under different impact conditions.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

It is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system, comprising:
a base;
a track supported by the base;
a block movably attached to the track and arranged to increase a pressure in a pressure chamber; and
a pressure sensor programmed to collect pressure data from the pressure chamber when the block increases the pressure in the pressure chamber.

2. The system of claim 1, further comprising a spring connected to the base and to the block.

3. The system of claim 2, wherein the spring is arranged to move the block toward the base.

4. The system of claim 1, wherein the pressure chamber is deformable.

5. The system of claim 1, wherein the pressure chamber is fixed to one of the block and the base.

6. The system of claim 1, further comprising a tube connected to the pressure chamber and a plunger disposed in the tube, wherein the block is arranged to move the plunger toward the pressure chamber.

7. A system, comprising:
a base;
a track supported by the base;
a block movably attached to the track;
a spring connected to the base and to the block;
a pressure chamber attachable to the block and deformable from an undeformed state to a deformed state; and
a pressure sensor attachable to the pressure chamber.

8. The system of claim 7, wherein the pressure chamber is disposed between the block and an impact surface of the base.

9. The system of claim 8, wherein the block has a surface and facing the impact surface.

10. The system of claim 7, wherein the spring is arranged to move the block toward an impact surface of the base.

11. The system of claim 10, wherein the pressure chamber is fixed to a surface of the block, and the spring is arranged to move the pressure chamber to contact the impact surface.

12. The system of claim 7, wherein the pressure chamber is deformable to the deformed state upon contact with the base.

13. The system of claim 12, wherein the pressure sensor is programmed to collect pressure data of the pressure chamber when the pressure chamber deforms from the undeformed state to the deformed state.

14. The system of claim 7, wherein the pressure chamber includes a lid, and the pressure sensor is disposed in the lid.

15. The system of claim 14, wherein the lid has an inner surface, and at least a portion of the pressure sensor is attachable to the inner surface of the lid.

16. A system, comprising:
a base;
a track supported by the base;
a block movably attached to the track;
a pressure chamber fixed to the base;
a tube connected to the pressure chamber;
a plunger disposed in the tube; and
a pressure sensor attachable to the pressure chamber.

17. The system of claim 16, wherein the block is arranged to move the plunger toward. the pressure chamber from a first position to a second position.

18. The system of claim 17, wherein the pressure sensor is programmed to collect pressure data of the pressure chamber when the plunger is in the second position.

19. The system of claim 17, wherein at least a portion of the plunger is disposed in a cavity of the pressure chamber when the plunger is in the second position.

20. The system of claim 16, further comprising a spring connected to the base and to the block.
